(19) United States
(12) Patent Application Publication
(10) Pub. No.: US 2010/0097237 A1
(43) Pub. Date: Apr. 22, 2010

(54) SAFETY DEVICE

(76) Inventor: Peter Nygaard Christiansen, Auning (DK)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 12/529,150

(22) PCT Filed: Feb. 29, 2008
(86) PCT No.: PCT/DK08/00085

§ 371 Date: Aug. 28, 2009

(30) Foreign Application Priority Data
Mar. 1, 2007 (DK) PA 2007 00307

(51) Int. Cl. G08B 21/00

(52) U.S. Cl. 340/686.6

(57) ABSTRACT

A proximity alert system for monitoring the presence of at least one object, and has a portable master unit and at least one slave unit. The slave units are attachable to an object. the master unit has a warning member and a device for causing outputting of a warning signal when the distance between the master unit and at least one of the slave units exceeds a predetermined adjustable value. The master unit is adapted to control the connection to the slave units and cause a warning signal to output if a connection fails. An adhesive member is provided for attaching a slave unit to an object. The system is applicable to different kinds of objects, in particular, small objects and personal belongings like glasses, medicine contained in pill bottles, purses, keys, passports, credit cards, cameras, mobile phones, portable computers and PDAs.

### BACKGROUND OF THE INVENTION

1. Field of the Invention

The present invention relates to a system for the monitoring of items, in particular of important and expensive personal belongings that require supervision.

2. Description of Related Art

It is known that important and expensive personal belongings often require supervision. The risk exists that personal belongings become lost or run into danger. In certain critical situations the owner of the personal belongings therefore must watch the personal belongings permanently. Personal belongings such as medicine of vital importance contained in a pill bottle, glasses can easily be lost.

A number of different technologies currently exist on the chip market. Mainly one must conclude that the “perfect match” does not exist yet. Either the solution must be made with a battery driven slave or the master must be larger then a key hanger.

But with time the solution with a slave without battery will probably emerge into smaller technologies allowing the master to be made small enough the fit a “perfect match”. Three different technologies are bluetooth (battery driven slave), ZigBee (battery driven slave), RFID (Non-battery driven slave).

Radio Frequency Identification (RFID) is an automatic identification method, relying on storing and remotely retrieving data using devices often referred to as RFID tags. An RFID tag is an object that can be attached to or incorporated into an object for the purpose of identification using radio waves. Chip-based RFID tags contain silicon chips and antennae. Passive tags require no internal power source, while active tags require a power source.

Passive RFID tags do not need an internal power supply. Driven by the radio signal, therefore the slave does not need a battery. Passive tags are for low distance communication only. They are small (down to 0.8 mm is claimed by some manufactures). Complementary metal-oxide-semiconductor (CMOS) is a major class of integrated circuits. CMOS technology is used in chips such as microprocessors, microcontrollers, static RAM, and other digital logic circuits. CMOS technology is also used for a wide variety of analog circuits such as image sensors, data converters, and highly integrated transceivers for many types of communication. Two important characteristics of CMOS devices are high noise immunity and low static power supply drain. Significant power is only drawn when its transistors are switching between on and off states; consequently, CMOS devices do not produce as much heat as other forms of logic such as transistor-transistor logic (TTL), a class of digital integrated circuits. CMOS also allows a high density of logic functions on a chip.

The minute electrical current induced in the antenna by the incoming radio frequency signal provides just enough power for the CMOS integrated circuit in the tag to power up and transmit a response. Most passive tags signal by backscattering the carrier signal from the reader. This means that the antenna has to be designed to both collect power from the incoming signal and also to transmit the outbound backscatter signal. The response of a passive RFID tag is not necessarily just an ID number; the tag chip can contain a non-volatile Electronically Erasable Programmable Read-Only Memory (EEPROM) for storing data. A EEPROM is a non-volatile storage chip used in computers and other devices to store small amounts of volatile (configuration) data. When larger amounts of more static data are to be stored (such as in USB flash drives) other memory types like flash memory are more economical.

The lack of an onboard power supply means that the device can be quite small: commercially available products exist that can be embedded in a sticker, or under the skin in the case of low frequency RFID tags.

The addition of the antenna creates a tag that varies from the size of a postage stamp to the size of a post card. Passive tags have practical read distances ranging from about 10 cm up to a few meters depending on the chosen radio frequency and the design and size of the antenna. Due to their simplicity in design they are also suitable for manufacture with a printing process for the antennas.

Unlike passive RFID tags, active RFID tags must be provided with their own internal power source which is used to power any integrated circuits that generate the outgoing signal. Active tags contain a battery, with a long life-time in most situations. The distance for active tags can be up to 80-100 meters. They are large, down to 4 cm is claimed by some manufactures. Active tags are typically much more reliable (e.g. fewer errors) than passive tags due to the ability for active tags to conduct a “session” with a reader. Active tags, due to their onboard power supply, also transmit at higher power levels than passive tags, allowing them to be more effective in “Radio Frequency challenged” environments like water (including most animals, which comprises a large proportion of water), metal (shipping containers, vehicles), or at longer distances. Many active tags have practical ranges of hundreds of meters, and a battery life of up to 10 years. Some active RFID tags include sensors such as temperature logging which have been used in concrete maturity monitoring or to monitor the temperature of perishable goods. Other sensors that have been married with active RFID include humidity, shock/vibration, light, radiation, temperature and atmospherics like ethylene. Active tags typically have much longer range and larger memories than passive tags, as well as the ability to store additional information sent by the transceiver.

U.S. Pat. No. 6,246,376 B1 discloses a system and method for wireless communication between two devices allows the transfer of location information through a cellular or “bluetooth” link that can be used to provide a continuous indication of estimated distance and direction relative to the two devices in communication with one another.

U.S. Pat. No. 7,019,643 B2 discloses a monitoring system for monitoring a direction of a monitored device when the monitored device is positioned further than a predetermined distance from a monitoring device. The monitoring device receives a locator signal from the monitored device and produces a direction indication that indicates the direction of the received locator signal. If the monitoring device no longer receives the locator signal, the direction indication indicates the direction of the last received locator signal.

U.S. Pat. No. 6,570,504 B2 discloses a system for selectively detecting the presence of a plurality of objects in proximity to a person. The system includes a plurality of child units each having a first communicating device (such as a transceiver) for sending a locator signal and for receiving a control signal. Further, the system includes a parent unit having a second communicating device for receiving the locator signal from at least one of the plurality of child units, a processor for monitoring the at least one child unit and for determining whether the child unit is within a preselected range, at least one alarm for signalling the person when the selected child unit is outside the preselected range, and controls for selectively controlling the child units to be monitored and for controlling activation of the child units.

U.S. Pat. No. 7,119,677 B2 discloses a device directed towards a system for the monitoring of persons, in particular of children and adults requiring supervision. The system comprises a portable transmitter, a receiver and a warning device provided at the receiver as well as means by which the warning device is caused to output a warning signal when the distance between the transmitter and the receiver exceeds a pre-determined adjustable value.

U.S. Pat. No. 5,557,259 A discloses a proximity alert and direction indicator is provided that allows an observer to monitor the proximity of a subject under surveillance, particularly a child. The subject wears a transmitter removeably attached to the shoe. The observer wears a receiver-containing bracelet. The receiver contains a proximity detector with threshold set that emits an audible sound when the distance between the subject and the observer exceeds some preset distance. The receiver also contains a direction finder with graphic display that shows the observer the direction to the subject.

U.S. Pat. No. 7,038,589 B2 discloses a portable apparatus to track an object includes a transmitter adapted to sending pulses of known duration and intensity; a receiver having one or more antennas to receive the pulses of known duration and intensity from the transmitter, the receiver and the transmitter having synchronized clocks to determine signal propagation time and distance, and wherein an alarm is generated if the determined distance exceeds a preset value.

The prior art suffer fron the drawback that the systems are difficult to attach to an object, in particular small objects. The attachment methods therefor impose a limit to the object to which the system can be applied.

UK Patent GB 2375424 concerns a personal Items protection alarm, which includes a transceiver which is worn by the user and transponder which is attached to the personal item the user wishes to protect, for example a wallet or mobile phone. The transceiver is controlled by an on/off switch. When the transceiver is on, it checks the protected object is within the preset range by emitting a return signal. When the preset range is exceeded, the signal is not returned to the transceiver which will then activate the alarm to alert the user that an object has left their possession, by way of sound and vibration.

### SUMMARY OF THE INVENTION

It is an object for the present invention to provide a system of the kind initially specified which does not have these disadvantages. In particular, an uncomplicated attachment is desired. It is further an object of the present invention to specify a device that can be fully implemented in an electrical device such as a mobile telephone or a PDA.

The objects of the present invention can be accomplished by a device as of the initially described type in which the at least one slave unit is provided with an adhesive member, which adhesive member is adapted to be attached to an object so that the slave unit is attached to the object. Hereby, it is achieved that the system can be applied in relation to different kinds of objects, in particular small objects and personal belongings like glasses, medicine contained in a pill bottle, a purse, keys, a passport, a credit card, a camera, a mobile phone, a portable computer and a PDA. It should be underlined that the pre-determined value can be adjustable. The system is superior compared to the systems available on the marked due to the fact that the slave units can be very small. Accordingly, the system can be applied and attached to a huge number of different types of objects. Furthermore, the slave units are portable and do not take up much space for storage.

In an embodiment of the present invention, the at least one slave unit is provided with a sticker member, which sticker member is adapted to be attached to an object. This provides an easy way of providing the slave unit with an adhesive member. Accordingly, the system can be used in relation to different types of objects. A sticker member can be made as a sticker. One possibly way for achieving an adhesive member is to use a tape such as 3M 300 LSE. This is a double sided sticking tape which is highly effective fox fixing small articles such as a slave unit to a purse or to jewellery carried by a person.

In an embodiment of the present invention, the master unit comprises setting means for setting the master unit. Hereby, it is achieved that the master unit can be applied to change the settings of the master unit. It is possible to apply coding means that enables the user of the system to set the antenna signal strength so that the pre-determined distance between the master unit and the slave units can be altered. It is also possible to apply the setting means to set the frequency of the master poll for controlling the connection of the slave units.

In another embodiment of the present invention, the master unit comprises an antenna. Hereby it is achieved that the construction size of the master unit and the slave units can be reduced. The master unit can have a printed-on antenna for this purpose.

It is beneficial that the master unit can be switched on and off in order to provide a system that is activated only when required. According, energy can be saved. Moreover, the system can be deactivated when required, for instance if a PDA is sent for corrective maintenance. In such situations the distance between the master unit and the slave unit may exceed the pre-determined distance without activation of the alarm.

Likewise it would be beneficial that the slave unit can be switched on and off hereby providing a system that is activated only when required. Accordingly, the system can be deactivated when required, for instance when an object to which a slave unit is attached is sent for corrective maintenance. In such situations the distance between the master unit and the slave unit may exceed the pre-determined distance. When the slave unit is switched off, no alarm will be activated.

In a still further embodiment of the present invention, the slave unit comprises a passive RFID tag. Hereby it is achieved that the slave unit requires no internal power supply. Eectrical current may be induced in the antenna by the incoming radio frequency signal. The antenna can be designed to both collect power from the incoming signal and also to transmit a signal. Slave units comprising passive RFID's can be quite small.

In another embodiment of the present invention, the slave unit comprises an active RFID tag. When possible active RFID tags provided with their own internal power source can be applied. Active tags are typically much more reliable than passive tags due to the ability for active tags to conduct a “session” with a reader. Active tags, due to their onboard power supply, also transmit at higher power levels than passive tags, allowing them to be more effective in “RF challenged” environments like water, metal, or at longer distances. It is possible to apply tags provided with batteries. It is also possible to apply tags that get electrical energy directly from an electrictical device such ad a PDA.

It is beneficial that the master unit comprises storage means for storages of slave units. Hereby it is achieved that extra slave units can be carried with the master unit. These extra slave units can be applied to extra items or as spare parts when required.

In an embodiment of the present invention, the master unit is provided with means capable of producing an optical warning signal or an acoustic warning signal, or both, can be provided as the warning signal. It is possible to apply a system capable of producing a warning signal that change, for example, to become louder or faster, as the distance between the master unit and the slave units increases. It is furthermore possible to provide a number of light-emitting diodes of which a number increasing with the distance is activated. The user of the system thereby receives additional information, on the one hand. The attention value of the warning signal is thereby increased, on the other hand, so that the user of the system can react faster.

In an embodiment of the present invention, at least one of the master unit and the slave unit are battery operated. This provides an easy way of providing the master unit and the slave unit with the required energy.

In an embodiment of the present invention, at least one of the master unit and the slave unit has a housing made of plastic. Hereby it is achieved that the housing can be made in many ways and shapes.

In an embodiment of the present invention at least one of the master unit and the slave unit has a printed-on antenna. Hereby, it is achieved that the construction size of the master unit or the slave units can be reduced.

In an embodiment of the present invention, the an emergency call is made to a police station when the warning member device is caused to output a warning signal as the distance between the master unit and at least one of the slave units exceeds a pre-determined adjustable value. Hereby, it is achieved that the system can be used to inform a police station about for instance a robbery.

In an embodiment of the present invention, the master unit and the slave operate according to the radio principle, with radio frequency modulation. Hereby, it is achieved that the system can apply known technique. This will ensure high validity.

It may be beneficial to apply a system provided with means for producing at least one of an acoustic warning signal and an optical warning signal.

In an embodiment of the present invention, at least one slave unit has one ore more light-emitting diodes that light up, when the distance between the slave unit and the master unit exceeds the pre-determined value. Hereby, it is achieved that the slave unit becomes easy to see. This will help the user of the system to locate the slave units and hence the objects to which the slave units are attached.

In an embodiment of the present invention, the system is provided with means for sending a message when a pre-determined distance is exceeded. Hereby it is achieved that the system can be used to inform for instance the police, relatives or another target audience that the slave unit and thus an object is “out of range”. The system can apply one distance (for instance, 2 m) as threshold distance for activating the alarm and another threshold distance (for instance, 15 m) for activating the sending of a message. The message can for instance be sent to a land telephone line, a mobile telephone (for instance by SMS) or as an e-mail to a computer.

In an embodiment of the present invention the master unit is provided with means for receiving a USB (universal serial bus) flash drive with coding information. The coding information can be transferred to the USB flash drive by means of a computer. Afterwards, the USB flash drive can be used to transfer the coding information to the master unit. The coding information may contain information about the item which is to be protected.

In an embodiment of the present invention, at least one of the transmitter and the receiver is provided with a GPS receiver. Hereby it is achieved that the system can be used to monitor the receiver's location, speed and direction location of the master unit or the slave units and thus the items. The information about position may be used to track the master unit, the slave units and thus the items if desired. The tracking can be performed by the police if the are informed by an automatic message sent from the system.

It would be beneficial that both the master unit and the slave units are portable.

In an embodiment of the present invention, the master unit has a plurality of channels for different slave units. Hereby, it is achieved that the same master unit can be applied for several different slave units and hence several different items.

The sticker member may be adapted to be attached to different kinds of surfaces and structures. It is possible to apply different types of glue in order to provide the most expedient and appropriate attachment, which can be adapted to specific requirements.

In a preferred embodiment for the invention, the master unit can be integrated in a mobile phone. By integrating the master unit in a mobile phone this master unit could be placed on one of the existing printing boards in the mobile phone and the existing antenna can probably partly or fully be used for the signals that are communicating with the slave units. Moreover, power supply could be the battery, which is part of the mobile phone, in this way no extra power supply is needed for driving the master unit. As the master unit only with some time intervals, at least with some times per minute transmit a signal, the power demand for this master unit can be very small. For transmitting a signal to the person carrying the mobile phone, the mobile phone has all necessary equipment for sending an alert to the person. One way is, of course, to use a special ring signal to indicate that one protected device is forgotten or outside range. Another way is using the mobile phone display to tell exactly which device is missing. Placing the master unit in a mobile phone at an existing printed circuit board will probably only use an area of that printed board, this is as small as one cm2.The whole master unit could probably be build as one integrated circuit, then the area demand in the mobile phone will be reduces to a great extend. It is also possible in the mobile phone to let the master unit communicate with processor means that already exist in the mobile phone. This processor then has to take over the communication with the slave units a few times per minute. For a modern microprocessor, which is part of normal mobile phones, there is sufficient room in the software applications for also running a programme that is controlling slave units.

The invention is not limited to the described embodiments which can be modified in many ways. This applies in particular to the shape and the materials of the master unit.

Preferred embodiments of the present invention will now be more particularly described, by way of example, with reference to the accompanying drawing, wherein:

### BRIEF DESCRIPTION OF THE DRAWINGS

FIG. 1 shows a block diagram of the master unit according to the one embodiment of the invention;

FIG. 2 shows a block diagram of the slave unit according to the one embodiment of the invention;

FIGS. 3a & 3b each show a schematic view of a respective one of two states of an embodiment of the present invention;

FIG. 4 shows a schematic view of an embodiment of the present invention;

FIG. 5 shows a schematic view of two states of another embodiment of the present invention; and

FIG. 6 shows a schematic view of a slave unit according to the present invention.

### DETAILED DESCRIPTION OF THE INVENTION

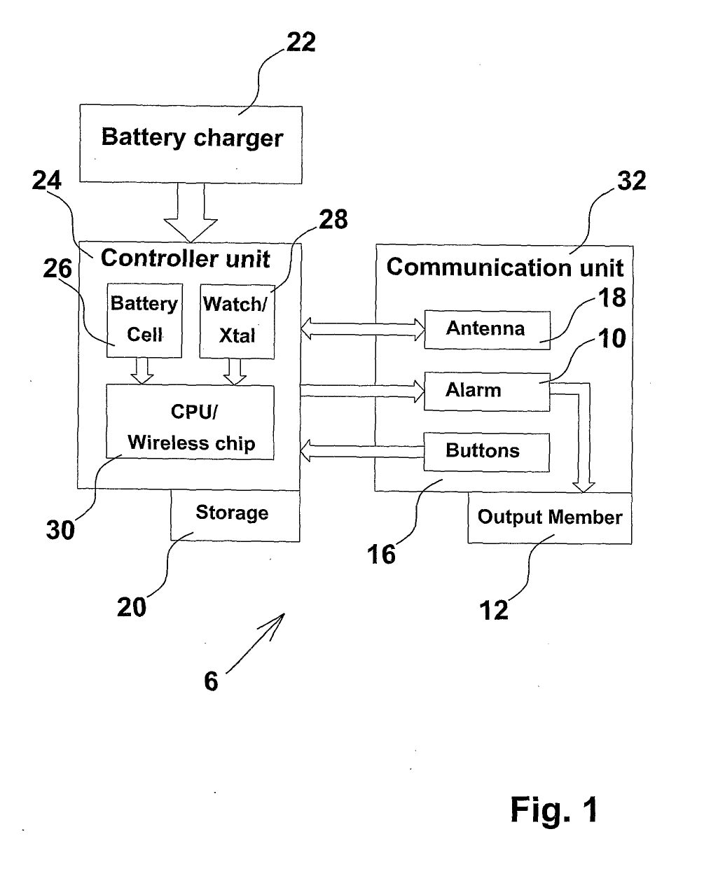

FIG. 1 illustrates a block diagram of a master unit 6 according to one embodiment of a system (of which only the master unit 6 is shown in FIG. 1) according to the invention. The master unit 6 comprises a battery charger 22, a controller unit 24 comprising a battery cell 26, a Watch/Xtal 28, a CPU/Wireless chip 30. The master unit 6 also comprises a communication unit 32 with an antenna 18, an alarm 10, buttons 16, an output member 12 and a storage member 20 for storage of slave units (not shown). The battery charger 22 that can be either placed in an external docking station or in the master unit 6. The battery charger 22 is responsible for charging of the battery cell 26 in the controller unit 24. The controller unit 24 is mandatory and placed in the master unit 6. The controller unit 24 is adapted to take care of controlling the communication unit 24 and the verification of identification (ID) of each slave unit (not shown). The controller unit 24 consists of a battery cell 26 that provides power to the master unit 6. The battery cell 26 can be a rechargeable battery, capacitor or any other device adapted to provide power to the master unit 6. The Watch/Xtal 28 may comprise a CPU 30 external crystal and/or watchdog circuit depending of the chosen technology. Some technologies provide internal crystal and watchdog, therefore Watch/Xtal 28 is optional in the controller unit 24.

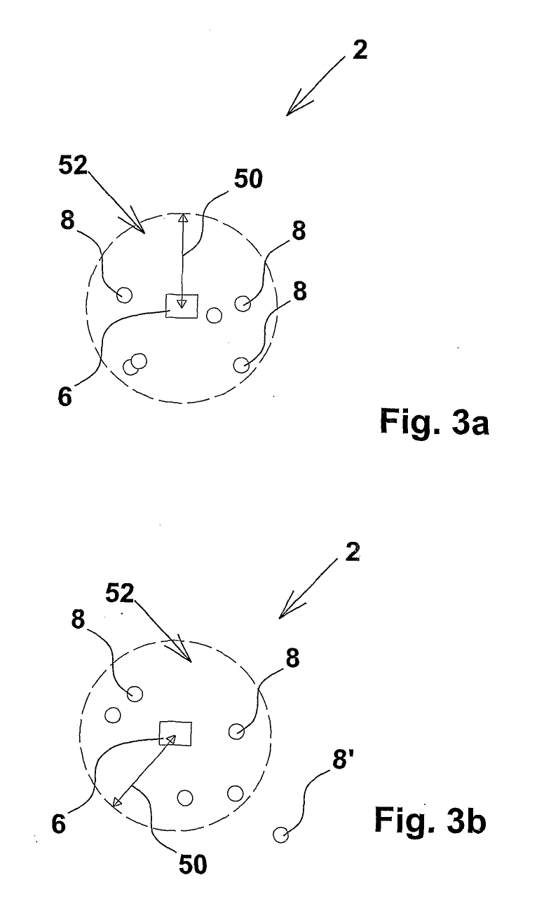

The master unit 6 has the purpose of controlling the connection to a number of slave units (shown in FIG. 3-5) and activating an alarm 10 and an output member 12 if one of the connections fails. The output member 12 can for instance be a loud speaker adapted to produce a warning sound or a lamp assembly adapted to produce an optical warning signal. Controlling the connection to a slave unit (not shown) can simply be done by retrieving the ID of the slave unit. If the ID can be retrieved the slave unit is identified as “within range” otherwise the slave is unaccounted for. By setting the antenna signal strength the distance between the master unit 6 and the slave units can be set. The setting can be done buy means of buttons 16 provided in the communication unit 32. The hardware design of the master unit 6 can be realized in different ways, depending of the wireless technology in use. FIG. 1 is a general block diagram of a master unit, made by an arbitrary technology.

The CPU/Wireless chip 30 provides the means of controlling the communication to slave unit (not shown) and the verification of their IDs. Depending of the chosen technology the CPU/Wireless chip 30 can be either one or more integrated circuits. The communication unit 32 is a mandatory part of the master unit 6 and consist of the peripheral communicators. The antenna 18 is used for communication with slave units. For some technologies the antenna 18 is also used for energy transfer to slave units, but this is not always the case.

Either of the alarm 10 and output member 12 comprises a speaker adapted to produce an alarm sound: The alarm 10 that is mandatory or the output member 12 can consist of a speaker, buffer or similar devices for sound production, diodes or similar devices for light. It could also be another alarm device e.g. a vibrator device for blind users. One or more buttons 16 can be used as an optional feature that can be added to the master unit 6. The purpose of the buttons 16 could be turning the unit off/on, selecting lost slave units that shall not be controlled any more. The master unit 6 can be very small and fit in a key hanger, mobile phone, ball pen or other equipment that is easy to carry.

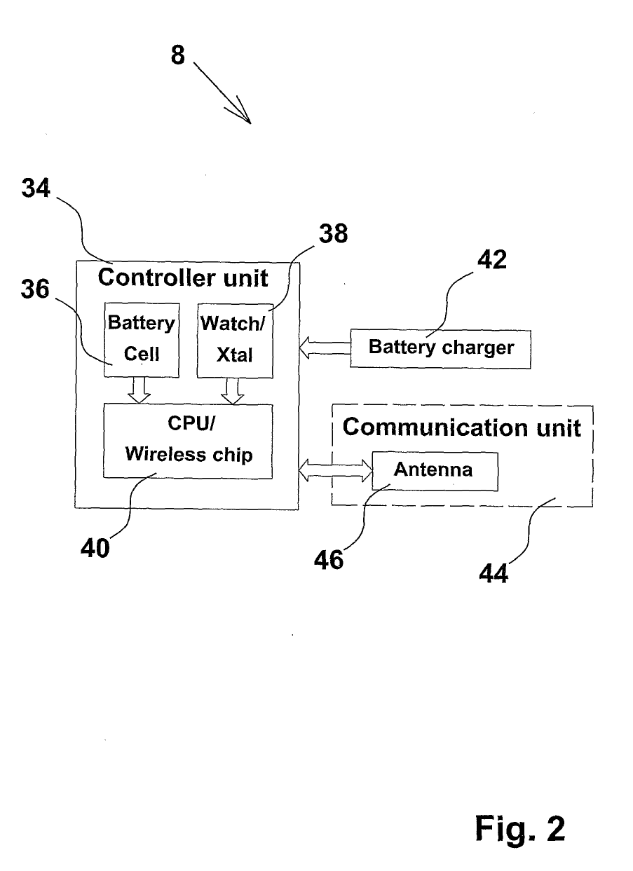

FIG. 2 illustrates a block diagram of a slave unit 8 according to one embodiment of a system according to the invention. The slave unit 8 comprises a controller unit 34 and a communication unit 44. The controller unit 34 comprises Watch/Xtal 38, a CPU/ Wireless chip 40 and a battery cell 36 adapted to be charged by a battery charger 42. The communication unit 44 comprises an antenna 46.

The slave unit 8 has the purpose of passively answering a control connection from the master unit (6, shown in FIG. 1). The answer shall just consist of a slave unit ID, after sending the answer the slave shall “sleep” until the next control connection is requested by the master unit. Like on the master unit, the slave unit 8 can be realized in different ways, depending on the chosen technology.

The different parts of the slave unit 8 have the following functionality: The battery charger 42 is only optional as some technologies provide power to the controller unit 34 through the antenna 46. If battery driven technologies is used a battery charger 42 must be included either in the slave unit 8 or as a peripheral to the slave unit 8. The controller unit 34 is mandatory and placed in the slave unit 8, it takes care of holding and transmission of a slave ID to the master unit. Depending of the technology choice the controller unit 34 consists of a battery cell 36 that is an optional part of the slave unit 8 that exists if a battery driven technology is chosen. This can be a number of different technologies e.g. rechargeable a battery, a capacitor or any other device adapted to provide power to the slave unit 8.

The Watch/Xtal 38 might, depending of the chosen technology, be equipped with a CPU external crystal and/or watchdog circuit. Some technologies provide internal crystal and watchdog, therefore this part is optional in the controller unit 34.

The CPU/Wireless chip 40 provides the means for waking up on a signal from the master unit and transmission of a slave ID to the master unit. Depending of the chosen technology this part can be either one or more integrated circuits.

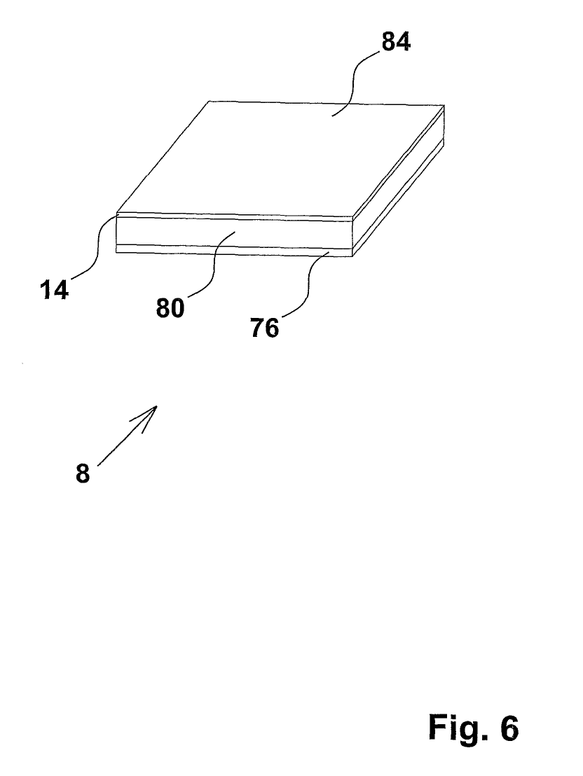

The communication unit 44 is a mandatory part of the slave unit 8 and comprises the peripheral communicators. The antenna 46 is used for communication with the master unit. For some technologies the antenna 46 is also used for energy reception, but this is not always the case. The slave unit 8 can be designed so that it has a small size and is preferable so thin that it fits into a sticker (shown in FIG. 6) that can be placed on and taken of small portable items e.g. insulin pen, mobile phone, credit card, glasses or any item that one can bring along on the road and that one might forget.

FIGS. 3a & 3b illustrate two states of an embodiment of the present invention. FIG. 3a shows a system 2 according to the invention. The system 2 comprises a master unit 6 and a number of slave units 8 arranged in an idle area 52 within a communication distance 50 from the master unit 6. The system 2 is in an idle state in which all slave units 8 are within a given distance 50 of the master unit 6.

FIG. 3b shows the same system 2 as shown in FIG. 3a; however, the system 2 is in the alarm state. One of the slave units 8′ is located out of the idle area 52.

When the slave unit 8′ is out side the communication range 50 (as shown in FIG. 3b) the master unit 6 does not receive the slave ID of the actual slave unit 8′. Accordingly, the system 2 goes into the alarm state. In the alarm state the alarm part of the master unit 6 is activated and the polling continues. When the slave unit 8 comes within the communication range again the alarm state is ended and the system 2 returns to the idle state.

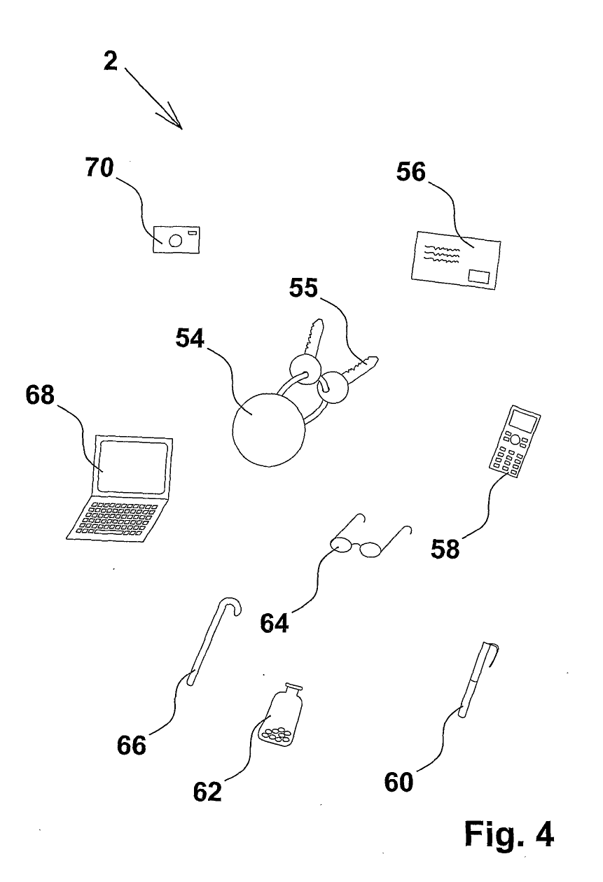

It should be noted that the each slave unit 8, 8′ is intended to be attached to an object (shown in FIGS. 4 & 5). The communication distance 50 can, e.g., be 2 meter, and the master poll for their existence with a certain frequency can e.g. be 0.1 Hz.

FIG. 4 illustrates a schematic view of a system 2 according to the present invention. The system 2 comprises a master member 54 comprising a master unit, which master member 54 is attached to a bunch of keys 55. The system 2 comprises a credit card 56, a mobile phone 58, an insulin injection pen 60, a bottle of pills 62, glasses 64, a walking stick 66, a portable computer 68 and a camera 70 each provided with a slave unit (not shown). It should me underlined that the master member 54 can be attached to i.e. an USB flash drive or any other device that can be carried by the user of the system 2.

In use the master unit of the master member 54 receives slave ID's from each of the slave units (each slave unit sends out different slave ID's). If one of the items 56, 58, 60, 62, 64, 66, 68, 70 is out side the communication range the master unit does not receive the slave ID of the actual slave unit and the system 2 goes into the alarm state in which one or more warning signals are outputted. In the alarm state the alarm part of the master unit is activated and the polling continues. When all slave units are within the communication range again the alarm state is ended and the system 2 returns to the idle state. It is possible to apply a system having slave units that send out the same slave ID. It would be beneficial to apply a system provided with means for changing the slave ID's for instance when several users apply systems according to the invention. The means for changing the slave ID's can be used to prevent that the systems interact.

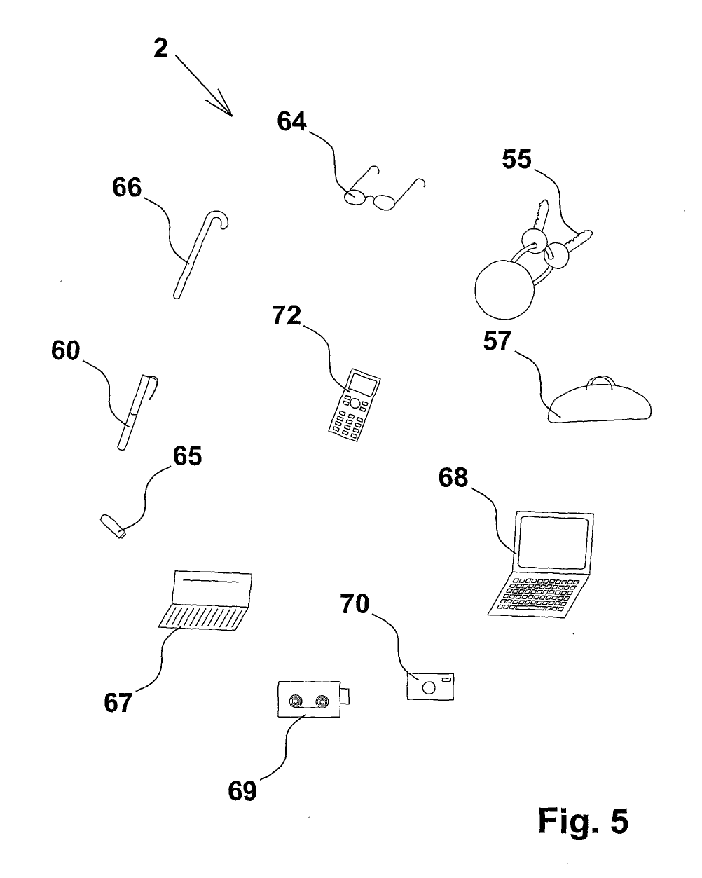

FIG. 5 illustrates a schematic view of a system 2 according to the present invention. The system 2 comprises an electrical device 72 (that for instance can be a mobile telephone, a PDA) and glasses 64, a bunch of keys 55, a bag 57, a portable computer 68, a camera 70, a video tape 69, a purse or wallet 67, a USB (universal serial bus) flash drive 65, a injection pen 60 and a walking stick 66 each provided with a slave unit (not shown). The electrical device 72 comprises a master unit (not shown) that is adapted to communicate with the slave units. The electrical device 72 provides the master unit with power. Accordingly, no power supply within the master unit is required.

In use the master unit of the master member 72 receives slave ID's from each of the slave units each sending out different slave ID's. In the case that one of the items 55, 57, 60, 64, 65, 66, 67, 68, 69, 70 is out side the communication range the master unit does not receive the slave ID of the actual slave unit and the system 2 goes into the alarm state and one or more warning signals are outputted. In the alarm state the alarm part of the master unit is activated and the polling continues. When all slave units are within the communication range again the alarm state is ended and the system 2 returns to the idle state. It should be underlined that a huge number of slave units can be applied.

FIG. 6 illustrates a schematic view of a slave unit 8 according to the present invention. The slave unit 8 comprises a plate 80 made of a resilient material (for instance, foam rubber), which plate 80 is sandwiched between a RFID chip 76 and a sticker 14 provided with a protective sheet 84.

In use the protective sheet 84 is removed from the sticker 14 so that the adhesive area of the sticker 14 is ready for being attached to an object. Since the plate 80 is made of a resilient the material, the plate 80 permits that the slave unit 8 can be attached to objects having curved surfaces such as bottles and casings.

1-10. (canceled)

11. Proximity alert system for monitoring the presence of at least one object, which system comprises a portable master unit and at least one slave unit, which slave units are adapted to be attached to an object, which master unit comprises a warning member and means by which the warning member device is caused to output a warning signal when the distance between the master unit and at least one of the slave units exceeds a predetermined adjustable value, which master unit is adapted to control the connection to at least one slave unit and caused to output a warning signal if one connection fails, characterized in that the master unit is integrated in a mobile phone.

12. A system in accordance with claim 11, wherein at least one slave unit is provided with an adhesive member, which adhesive member is adapted to be attached to an object so that the slave unit is attached to the object.

13. A system in accordance with claim 12, wherein the adhesive member is a sticker member.

14. A system in accordance with claim 11, wherein the master unit comprises setting means for setting the master unit.

15. A system in accordance with claim 11, wherein the master unit comprises an antenna.

16. A system in accordance with claim 11, wherein the master unit can be switched on and off.

17. A system in accordance with claim 11, wherein the slave unit can be switched on and off

18. A system in accordance with claim 11, wherein the slave unit comprises a passive Radio Frequency Identification (RFID) tag.

19. A system in accordance with claim 11, wherein slave unit comprises an active RFID tag.

20. A system in accordance with claim 11, wherein the master unit comprises storage means for storages of slave units.
